(19) United States
(12) Patent Application Publication
(10) Pub. No.: US 2025/0125101 A1
(43) Pub. Date: Apr. 17, 2025

(54) INTERLOCK DEVICE

(71) Applicant: ABB SCHWEIZ AG, Baden (CH)

(72) Inventors: Tianyi Huang, Xiamen, Fujian (CN); Jiejun Lv, Xiamen, Fujian (CN); Mingshi Fan, Jiangmen, Guangdong (CN)

(21) Appl. No.: 18/695,937

(22) PCT Filed: Dec. 30, 2021
(86) PCT No.: PCT/CN2021/143378

§ 371 Date: Mar. 27, 2024

(51) Int. Cl. H01H 9/26; H02J 9/06

(52) U.S. Cl. CPC H01H 9/26; H02J 9/06

(57) ABSTRACT

An interlock device for a bypass device, which includes a Rack In Rack Out (RIRO) mechanism, configured to drive an Automatic Transfer Switching Equipment (ATSE) from a non-operating position to an operating position and drive the ATSE from the operating position to the non-operating position. Further, the interlock device includes a first interlock mechanism which is configured to prevent the RIRO mechanism from driving the ATSE from the non-operating position to the operating position when the first switch and the fourth switch are both switched on. The interlock device also includes a second interlock mechanism which is configured to prevent the RIRO mechanism from driving the ATSE from the non-operating position to the operating position when the second switch and the third switch are both switched on.

### FIELD

Embodiments of the present disclosure generally relate to the field of interlock device, and more particularly, to an interlock device for a bypass device.

### BACKGROUND

Bypass devices are used to provide an uninterruptible power supply to important loads. The bypass devices usually contain two main parts, Automatic Transfer Switching Equipment (ATSE) and Manual Transfer Switching Equipment (MTSE), each of them comprises two switches to switch the loads between two power supplies. The ATSE is used to operate in a normal condition. The MTSE is used to operate when the ATSE needs maintenance. When racking the ATSE in after the maintenance, the switches of the ATSE and MTSE need to be specially positioned so as to avoid two power supplies being connected to the loads at the same time, because it will lead to short-circuit between the two power supplies. Conventional interlock devices use controllers to position the switches of the ATSE and MTSE. However, these controllers are expensive, and the operation of the controllers is complex.

### SUMMARY

In view of the foregoing problems, various example embodiments of the present disclosure provide an interlock device for a bypass device capable of achieving interlock of the ATSE and MTSE in a manner of high efficiency, low cost, high reliability, and user friendly.

In a first aspect of the present disclosure, example embodiments of the present disclosure provide an interlock device for a bypass device. The bypass device is configured to switch a load between a first power supply and a second power supply and comprises a two-position Automatic Transfer Switching Equipment, ATSE, having a first switch and a second switch and a three-position Manual Transfer Switching Equipment, MTSE, having a third switch and a fourth switch, each of the first switch and the third switch is configured to connect the load to the first power supply or disconnect the load from the first power supply, and each of the second switch and the fourth switch is configured to connect the load to the second power supply or disconnect the load from the second power supply. The interlock mechanism comprises: a Rack In Rack Out, RIRO, mechanism, configured to drive the ATSE from a non-operating position to an operating position and drive the ATSE from the operating position to the non-operating position; a first interlock mechanism, configured to prevent the RIRO mechanism from driving the ATSE from the non-operating position to the operating position when the first switch and the fourth switch are both switched on; and a second interlock mechanism, configured to prevent the RIRO mechanism from driving the ATSE from the non-operating position to the operating position when the second switch and the third switch are both switched on. With these embodiments, the ATSE and MTSE cannot connect two power supplies to the load at the same time through using the first interlock mechanism and the second interlock mechanism, and no controller is needed to achieve the interlocking between the ATSE and MTSE.

In some embodiments, the first interlock mechanism comprises: a first locking assembly, comprising a first bar which is movable in a first direction; a first driving assembly, connected to the first locking assembly and configured to drive the first bar to different positions in the first direction according to different switch states of the first switch; a fourth driving assembly, connected to the first locking assembly and configured to drive the first bar to different positions in the first direction according to different switch states of the fourth switch, wherein when the first switch and the fourth switch are both switched on, the first bar is driven to a first locking position so as to prevent the RIRO mechanism from driving the ATSE from the non-operating position to the operating position; and when either of the first switch and the fourth switch is not switched on, the first bar is driven to other positions so as to not prevent the RIRO mechanism from driving the ATSE from the non-operating position to the operating position. With these embodiments, the first switch and the fourth switch are interlocked in a manner of high efficiency, low cost, and high reliability.

In some embodiments, the first driving assembly comprises: a first support; a second support; a first transmission part mounted on the first support and coupled to the first switch, wherein the first transmission part is configured to rotate relative to the first support when the first switch is switched between an ON state and an OFF state; and a second transmission part mounted on the second support and connected to the first transmission part, wherein the second transmission part is configured to be driven by the first transmission part to rotate relative to the second support in a direction opposite to the rotate direction of the first transmission part. With these embodiments, the switch states of the first switch can be transferred to the first interlock mechanism in a manner of high efficiency, low cost, and high reliability.

In some embodiments, the fourth driving assembly comprises: a third support; a third transmission part connected to the fourth switch, wherein the third transmission part is configured to move in a second direction when the fourth switch is switched between an ON state and an OFF state; and a fourth transmission part mounted on the third support and connected to the third transmission, wherein the fourth transmission part is configured to rotate relative to the third support when the third transmission part is moving in the second direction. With these embodiments, the switch states of the fourth switch can be transferred to the first interlock mechanism in a manner of high efficiency, low cost, and high reliability.

In some embodiments, the first locking assembly further comprises: a fourth support comprising a first hole; a first sleeve mounted in the first hole and suitable for the first bar to move therein in the first direction; a first elastic part coupled between the first sleeve and a step of the first bar and suitable for the first bar to move therein in the first direction; and a fifth transmission part comprising a first end connected to the first driving assembly and a second end connected to the fourth driving assembly, wherein the fifth transmission part is connected to the first bar, wherein the first bar is configured to be driven by the fifth transmission part in the first direction according to the movement of the first driving assembly or the movement of the fourth driving assembly. With these embodiments, the locking assembly can be driven according to the states of the first switch and the fourth switch in a manner of high efficiency, low cost, and high reliability.

In some embodiments, the first bar comprises a first portion having a first groove, a second portion having a second groove, and a second elastic part, wherein the second elastic part is disposed between the first groove and the second groove. With these embodiments, the first bar can be stretched in the first direction to avoid rigidity damage.

In some embodiments, the second interlock mechanism comprises: a second locking assembly, comprising a second bar which is movable in the first direction; a second driving assembly, connected to the second locking assembly and configured to drive the second bar to different positions in the first direction according to different switch states of the second switch; a third driving assembly, connected to the second locking assembly and configured to drive the second bar to different positions in the first direction according to different switch states of the third switch, wherein when the second switch and the third switch are both switched on, the second bar is driven to a second locking position so as to prevent the RIRO mechanism from driving the ATSE from the non-operating position to the operating position; and when either of the second switch and the third switch is not switched on, the second bar is driven to other positions so as to not prevent the RIRO mechanism from driving the ATSE from the non-operating position to the operating position. With these embodiments, the second switch and the third switch are interlocked in a manner of high efficiency, low cost, and high reliability.

In some embodiments, the second driving assembly comprises: a fifth support; a sixth support; a sixth transmission part mounted on the fifth support and coupled to the second switch, wherein the sixth transmission part is configured to rotate relative to the fifth support when the second switch is switched between an ON state and an OFF state; and a seventh transmission part mounted on the sixth support and connected to the sixth transmission part, wherein the seventh transmission part is configured to be driven by the sixth transmission part to rotate relative to the sixth support in a direction opposite to the rotate direction of the sixth transmission part. With these embodiments, the switch states of the second switch can be transferred to the second interlock mechanism in a manner of high efficiency, low cost, and high reliability.

In some embodiments, the third driving assembly comprises: a seventh support; an eighth transmission part connected to the third switch, wherein the eighth transmission part is configured to move in the second direction when the third switch is switched between an ON state and an OFF state; and a ninth transmission part mounted on the seventh support and connected to the eighth transmission, wherein the ninth transmission part is configured to rotate relative to the seventh support when the eighth transmission part is moving in the second direction. With these embodiments, the switch states of the third switch can be transferred to the second interlock mechanism in a manner of high efficiency, low cost, and high reliability.

In some embodiments, the second locking assembly further comprises: an eighth support comprising a second hole; a second sleeve mounted in the second hole and suitable for the second bar to move therein in the first direction; a third elastic part coupled between the second sleeve and a step of the second bar and suitable for the second bar to move therein in the first direction; and a tenth transmission part comprising a first end connected to the second driving assembly and a second end connected to the third driving assembly, wherein the tenth transmission part is connected to the second bar, wherein the second bar is configured to be driven by the tenth transmission part in the first direction according to the movement of the second driving assembly or the movement of the third driving assembly. With these embodiments, the locking assembly can be driven according to the states of the second switch and the third switch in a manner of high efficiency, low cost, and high reliability.

In some embodiments, the second bar comprises a third portion having a third groove, a fourth portion having a fourth groove, and a fourth elastic part, wherein the fourth elastic part is disposed between the third groove and the fourth groove. With these embodiments, the second bar can be stretched in the first direction to avoid rigidity damage.

In some embodiments, the RIRO mechanism comprises a rocking bar and a blocker fixed on the rocking bar, the blocker comprises a protrusion on its periphery, wherein a distance from one side of the protrusion to a center of the blocker is shorter than a distance from the other side of the protrusion to the center of the blocker. With these embodiments, the ATSE can be driven back to the non-operating position when the blocker is blocked by the first bar or the second bar.

In a first aspect of the present disclosure, example embodiments of the present disclosure provide an interlock device for a bypass device. The bypass device is configured to switch a load between a first power supply and a second power supply and comprises a three-position Automatic Transfer Switching Equipment, ATSE, having a first switch and a second switch and a three-position Manual Transfer Switching Equipment, MTSE, having a third switch and a fourth switch, each of the first switch and the third switch are configured to connect the load to the first power supply or disconnect the load from the first power supply, and each of the second switch and the fourth switch are configured to connect the load to the second power supply or disconnect the load from the second power supply. The interlock mechanism comprises: a Rack In Rack Out, RIRO, mechanism, configured to drive the ATSE from a non-operating position to an operating position and drive the ATSE from the operating position to the non-operating position; a first interlock mechanism, configured to allow the RIRO mechanism from driving the ATSE from the non-operating position to the operating position when the first switch is switched off; and a second interlock mechanism, configured to allow the RIRO mechanism from driving the ATSE from the non-operating position to the operating position when the second switch is switched off. With these embodiments, the ATSE and MTSE cannot connect two power supplies to the load at the same time through using the first interlock mechanism and the second interlock mechanism, and no controller is needed to achieve the interlocking between the ATSE and MTSE.

In some embodiments, the first interlock mechanism comprises: a first locking assembly, comprising a first bar which is movable in a first direction; a first driving assembly, connected to the first locking assembly and configured to drive the first bar to different positions in the first direction according to different switch states of the first switch, wherein when the first switch is switched on, the first bar is driven to a first locking position that will prevent the RIRO mechanism from driving the ATSE from the non-operating position to the operating position; when the first switch is switched off, the first bar is driven to another position that will not prevent the RIRO mechanism from driving the ATSE from the non-operating position to the operating position. With these embodiments, the first switch is locked in a manner of high efficiency, low cost, and high reliability.

In some embodiments, the first driving assembly comprises: a first support; a second support; a first transmission part mounted on the first support and coupled to the first switch, wherein the first transmission part is configured to rotate relative to the first support when the first switch is switched between an ON state and an OFF state; and a second transmission part mounted on the second support and connected to the first transmission part and the first locking assembly, wherein the second transmission part is configured to be driven by the first transmission part to rotate relative to the second support in a direction opposite to the rotate direction of the first transmission part. With these embodiments, the switch states of the first switch can be transferred to the first interlock mechanism in a manner of high efficiency, low cost, and high reliability.

In some embodiments, the first locking assembly further comprises: a third support comprising a first hole; a first sleeve mounted in the first hole and suitable for the first bar to move therein in the first direction; a first elastic part coupled between the first sleeve and a step of the first bar and suitable for the first bar to move therein in the first direction; and a third transmission part fixedly connected to the first bar and connected to the first driving assembly, wherein the first bar is driven by the third transmission part in the first direction according to the movement of the first driving assembly. With these embodiments, the locking assembly can be driven according to the states of the first switch in a manner of high efficiency, low cost, and high reliability.

In some embodiments, the first bar comprises a first portion having a first groove, a second portion having a second groove, and a second elastic part, wherein the second elastic part is disposed between the first groove and the second groove. With these embodiments, the first bar can be stretched in the first direction to avoid rigidity damage.

In some embodiments, the second interlock mechanism comprises: a second locking assembly, comprising a second bar which is movable in a first direction; a second driving assembly, connected to the second locking assembly and configured to drive the second bar to different positions in the first direction according to different switch states of the second switch; wherein when the second switch is switched on, the second bar is driven to a second locking position that will prevent the RIRO mechanism from driving the ATSE from the non-operating position to the operating position; when the second switch is switched off, the second bar is driven to another position that will not prevent the RIRO mechanism from driving the ATSE from the non-operating position to the operating position. With these embodiments, the second switch is locked in a manner of high efficiency, low cost, and high reliability.

In some embodiments, the second driving assembly comprises: a fourth support; a fifth support; a fourth transmission part mounted on the fourth support and coupled to the second switch, wherein the fourth transmission part is configured to rotate relative to the fourth support when the second switch is switched between an ON state and an OFF state; and a fifth transmission part mounted on the fifth support and connected to the fourth transmission part and the second locking assembly, wherein the fifth transmission part is configured to be driven by the fourth transmission part to rotate relative to the fifth support in a direction opposite to the rotate direction of the fourth transmission part. With these embodiments, the switch states of the second switch can be transferred to the first interlock mechanism in a manner of high efficiency, low cost, and high reliability.

In some embodiments, the second locking assembly further comprises: a sixth support comprising a second hole; a second sleeve mounted in the second hole and suitable for the second bar to move therein in the first direction; a third elastic part coupled between the second sleeve and a step of the second bar and suitable for the second bar to move therein in the first direction; and a sixth transmission part fixedly connected to the second bar and connected to the second driving assembly, wherein the second bar is driven by the sixth transmission part in the first direction according to the movement of the second driving mechanism. With these embodiments, the locking assembly can be driven according to the states of the second switch in a manner of high efficiency, low cost, and high reliability.

In some embodiments, the second bar comprises a third portion having a third groove, a fourth portion having a fourth groove, and a fourth elastic part, wherein the fourth elastic part is disposed between the third groove and the fourth groove. With these embodiments, the second bar can be stretched in the first direction to avoid rigidity damage.

In some embodiments, the RIRO mechanism comprises a rocking bar and a blocker fixed on the rocking bar, the blocker comprises a protrusion on its periphery, wherein a distance from one side of the protrusion to a center of the blocker is shorter than a distance from the other side of the protrusion to the center of the blocker. With these embodiments, the ATSE can be driven back to the non-operating position when the blocker is blocked by the first bar or the second bar.

It is to be understood that the Summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in examples and in a non-limiting manner, wherein:

FIG. 1 is a schematic view of a bypass device;

FIG. 2 is a schematic view illustrating an interlock device and switching assemblies in accordance with an embodiment of the present disclosure;

FIG. 3 is a schematic view illustrating a first state of the interlock device in accordance with an embodiment of the present disclosure;

FIG. 4 is a schematic view illustrating a second state of the interlock device in accordance with an embodiment of the present disclosure;

FIG. 5 is a schematic view illustrating a third state of the interlock device in accordance with an embodiment of the present disclosure;

FIG. 6 is a schematic view illustrating a fourth state of the interlock device in accordance with an embodiment of the present disclosure;

FIG. 7 is a schematic view illustrating a fifth state of the interlock device in accordance with an embodiment of the present disclosure;

FIG. 8 is a schematic view illustrating a sixth state of the interlock device in accordance with an embodiment of the present disclosure;

FIG. 9 is a schematic view illustrating a blocker in accordance with an embodiment of the present disclosure;

FIG. 10 is a schematic view illustrating a first bar and a second bar in accordance with an embodiment of the present disclosure;

FIG. 11 is a schematic view illustrating a first state of the interlock device in accordance with another embodiment of the present disclosure;

FIG. 12 is a schematic view illustrating a second state of the interlock device in accordance with another embodiment of the present disclosure; and

FIG. 13 is a schematic view illustrating a third state of the interlock device in accordance with another embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art to better understand and thereby implement the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

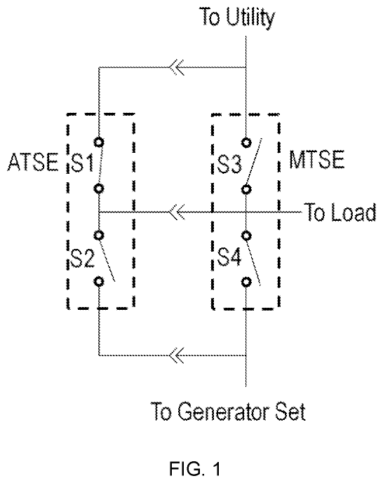

First of all, operational principles of a bypass device will be described with reference to FIG. 1. FIG. 1 is a schematic view of a bypass device.

As shown in FIG. 1, the bypass device of a load comprises an ATSE and a MTSE. The ATSE comprises a first switch S1 and a second switch S2, and the MTSE comprises a third switch S3 and a fourth switch S4. The first switch S1 and the third switch S2 are connected to a first power supply, for example, the utility, and the second switch S2 and the fourth switch S4 are connected to a second power supply, for example, a generator set.

Generally, in the bypass device, there are two types of ATSE, two-position ATSE and three-position ATSE, and one type of MTSE, three-position MTSE. In the two-position ATSE, there are only two states of the switches S1 and S2, i.e., S1 is switched on and S2 is switched off, and S1 is switched off and S2 is switched on. In the three-position ATSE, there are three states of the switches S1 and S2, i.e., S1 is switched on and S2 is switched off, S1 is switched off and S2 is switched on, and S1 and S2 are both switched off. In the three-position MTSE, there are three states of the switches S3 and S4, i.e., S3 is switched on and S4 is switched off, S3 is switched off and S4 is switched on, and S3 and S4 are both switched off.

Three are usually three positions of ATSE in the bypass device, an isolation position, a test position, and a connected position. The isolation position and the test position are also referred as non-operating positions, because the ATSE cannot be operated to switch the load between the first power supply and the second power supply in these positions. The connected position is also referred as an operating position, because the ATSE can be operated to switch the load between the first power supply and the second power supply in this position.

During a normal condition, the ATSE is used to switch the load between the utility and the generator set. That is, when the power supply of the utility is normal, the first switch S1 is switched on and the second switch S2 is switched off, such that the load is powered by the utility; when the power supply of the utility is abnormal, the first switch S1 is switched off and the second switch S2 is switched on, such that the load is powered by the generator set. During this condition, the third switch S3 and the fourth switch S4 of the MTSE are both switched off.

When the ATSE needs maintenance, the ATSE is racked out, that is, disconnected from the utility, the generator set and the load, and the MTSE is used to switch the load between the utility and the generator set. That is, when the power supply of the utility is normal, the third switch S3 is switched on and the fourth switch S4 is switched off, such that the load is powered by the utility; when the power supply of the utility is abnormal, the third switch S3 is switched off and the fourth switch S4 is switched on, such that the load is powered by the generator set.

After the maintenance, when the ATSE is racked in, that is, connected to the utility, the generator set and the load, switches S1-S4 need to be specially positioned to avoid the utility and the generator set are connected to the loads at the same time, because it will lead to short-circuit between two power supplies. For example, in the situation that the third switch S3 is switched on, if the second switch S2 is switched on during the racking in of the ATSE, the load will be connected to the utility and the generator set at the same time.

To avoid the short-circuit situation, interlock devices are used to interlock the switches S1-S4. However, conventional interlock devices use controllers to interlock the switches S1-S4, and sensors are required to detect the switch states of the switches S1-S4. As a result, these interlock devices are expensive and complicated to operate.

Thus, there is a need to perform the interlock operation in a manner of high efficiency, low cost, high reliability, and user friendly.

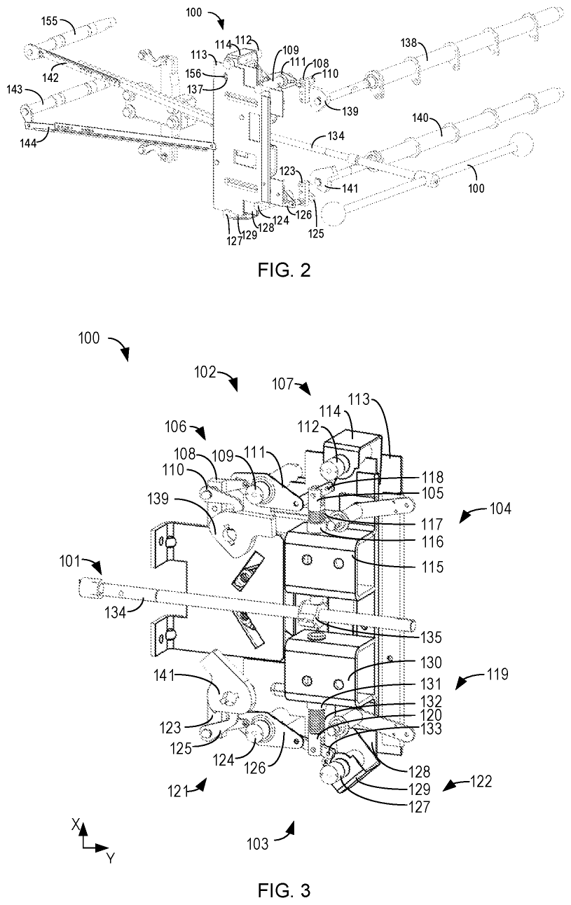

Hereinafter, the structure of connections between a two-position ATSE, a three-position MTSE and an interlock device in accordance with an embodiment of the present disclosure will be described in detail with reference to FIG. 2. FIG. 2 is a schematic view illustrating an interlock device and switching assemblies in accordance with an embodiment of the present disclosure.

As shown in FIG. 2, the interlock device 100 is coupled to a first shaft 138 of the first switch S1 through a first cam 139 that is fixedly connected to the first shaft 138, coupled to a second shaft 140 of the second switch S2 through a second cam 141 that is fixedly connected to the second shaft 140, connected to a third shaft 155 of the third switch S3 through a first link 142 that is actively connected to the third shaft 155, and connected to a fourth shaft 143 of the fourth switch S4 through a second link 144 that is actively connected to the fourth shaft 143. The first cam 139 and the second cam 141 are engaged with the interlock device 100 when the ATSE is racked in, and can be disengaged from the interlock device 100 when the ATSE is racked out.

When the first switch S1 is switched between ON and OFF states, the first shaft 138 and the first cam 139 are rotating between different positions. Accordingly, the switch states of the first switch S1 are transmitted to the interlock device 100. The switch states of the second switch S2 are transmitted to the interlock device 100 in a same way.

When the third switch S3 is switched between ON and OFF states, the third shaft 155 is rotating accordingly, and the first link 142 is moving between different positions. Accordingly, the switch states of the third switch S3 are transmitted to the interlock device 100. The switch states of the fourth switch S4 are transmitted to the interlock device 100 in a same way.

With above structures, the states of the switches S1-S4 can be transmitted to the interlock device 100 without requiring sensors. Thus, the cost of the interlock device 100 can be reduced.

Hereinafter, the structure of an interlock device in accordance with an embodiment of the present disclosure will be described in detail with reference to FIGS. 3-10. FIG. 3 is a schematic view illustrating a first state of the interlock device in accordance with an embodiment of the present disclosure.

As shown in FIG. 3, the interlock mechanism 100 comprises a Rack In Rack Out (RIRO) mechanism 101, a first interlock mechanism 102, and a second interlock mechanism 103. The RIRO mechanism 101 is used to drive the ATSE from a non-operating position to an operating position and drive the ATSE from the operating position to the non-operating position. The first interlock mechanism 102 is used to prevent the RIRO mechanism 101 from driving the ATSE from the non-operating position to the operating position when the first switch S1 and the fourth switch S4 are both switched on. The second interlock mechanism 103 is used to prevent the RIRO mechanism 101 from driving the ATSE from the non-operating position to the operating position when the second switch S2 and the third switch S3 are both switched on.

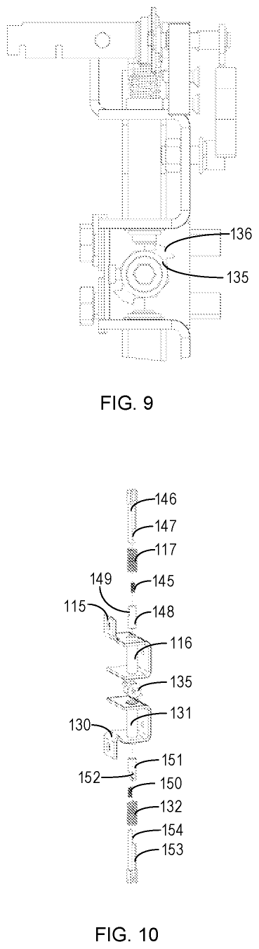

FIG. 9 is a schematic view illustrating a blocker in accordance with an embodiment of the present disclosure. As shown in FIG. 9, the RIRO mechanism 101 comprises a rocking bar 134 and a blocker 135 fixed on the rocking bar 134. The blocker 135 comprises a protrusion 136 on its periphery. A distance from one side of the protrusion 136 to a center of the blocker 135 is shorter than a distance from the other side of the protrusion 136 to the center of the blocker 135.

With the above structure, the ATSE can be easily racked back if the first bar is driven to the first locking position, or the second bar is driven to the second locking position.

In other embodiments, the blocker 135 can be other structures. The scope of the present disclosure is not intended to be limited in this respect.

As shown in FIG. 3, the first interlock mechanism 102 comprises a first locking assembly 104, a first driving assembly 106, and a fourth driving assembly 107. The first locking assembly 104 comprises a first bar 105 which is movable in a first direction X. The first driving assembly 106 is connected to the first locking assembly 104 and is used to drive the first bar 105 to different positions in the first direction X according to different switch states of the first switch S1. The fourth driving assembly 107 is connected to the first locking assembly 104 and is used to drive the first bar 105 to different positions in the first direction X according to different switch states of the fourth switch S4.

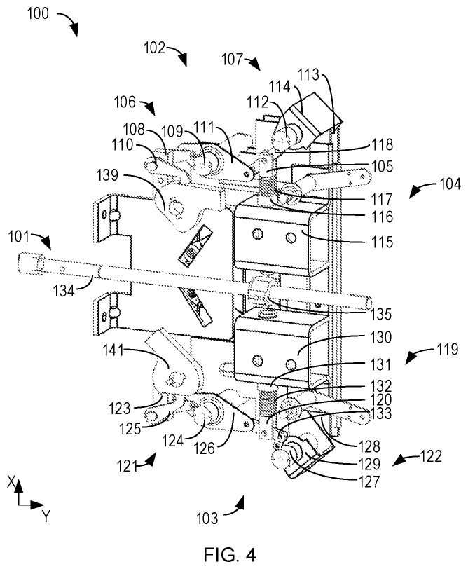

When the first switch S1 and the fourth switch S4 are both switched on, the first bar 105 is driven to a first locking position as shown in FIG. 3, so as to prevent the RIRO mechanism 101 from driving the ATSE from the non-operating position to the operating position. When either of the first switch S1 and the fourth switch S4 is not switched on, the first bar 105 is driven to other positions as shown in FIGS. 4-8, so as to not prevent the RIRO mechanism 101 from driving the ATSE from the non-operating position to the operating position.

As shown in FIG. 3, the first driving assembly 106 comprises a first support 108, a second support 109, a first transmission part 110, and a second transmission part 111. The first transmission part 110 is mounted on the first support 108 and is coupled to the first switch S1 through the first cam 139. The first transmission part 110 is configured to rotate relative to the first support 108 when the first switch S1 is switched between an ON state and an OFF state. The second transmission part 111 is mounted on the second support 109 and is connected to the first transmission part 110. The second transmission part 111 is configured to be driven by the first transmission part 110 to rotate relative to the second support 109 in a direction opposite to the rotate direction of the first transmission part 110.

In other embodiments, the first driving assembly 106 can comprise other elements. The scope of the present disclosure is not intended to be limited in this respect.

In the embodiment as shown in FIG. 3, the first transmission part 110 comprises a shaft mounted in a hole in the first support 118 and a first portion and a second portion mounted on the sides of the shaft. The first portion and the second portion of the first transmission part 110 are offset by a certain angle on the circumferential direction of the shaft. The second portion of the first transmission part 110 comprises a cylinder. In other embodiments, the first transmission part 110 can comprise other elements. The scope of the present disclosure is not intended to be limited in this respect.

In the embodiment as shown in FIG. 3, the second transmission part 111 comprises a first end and a second end. The first end of the second transmission part 111 comprises a groove to accommodate the cylinder on the second portion of the first transmission part 110. The second end of the second transmission part 111 comprises a cylinder. In other embodiments, the second transmission part 111 can comprise other elements. The scope of the present disclosure is not intended to be limited in this respect.

As shown in FIG. 3, the fourth driving assembly 107 comprises a third support 112, a third transmission part 113, and a fourth transmission part 114. The third transmission part 113 is connected to the fourth switch S4 through the second link 144. The third transmission part 113 is configured to move in a second direction Y when the fourth switch S4 is switched between an ON state and an OFF state. The fourth transmission part 114 is mounted on the third support 112 and is connected to the third transmission 113. The fourth transmission part 114 is configured to rotate relative to the third support 112 when the third transmission part 113 is moving in the second direction Y.

In other embodiments, the fourth driving assembly 107 can comprise other elements. The scope of the present disclosure is not intended to be limited in this respect.

In the embodiment as shown in FIG. 2, the fourth transmission part 114 is a U type transmission part comprising a cylinder 156 on one side of the U type transmission part. In other embodiments, the fourth transmission part 114 can comprise other elements. The scope of the present disclosure is not intended to be limited in this respect.

In the embodiment as shown in FIG. 2, the third transmission part 113 is a sheet comprising a groove 137 that used to accommodate the cylinder on the U type transmission part. In other embodiments, the third transmission part 113 can comprise other elements. The scope of the present disclosure is not intended to be limited in this respect.

As shown in FIG. 3, the first locking assembly 104 further comprises a fourth support 115, a first sleeve 116, a first elastic part 117, and a fifth transmission part 118. The fourth support 115 comprising a first hole. The first sleeve 116 is mounted in the first hole and suitable for the first bar 105 to move therein in the first direction X. The first elastic part 117 is coupled between the first sleeve 116 and a step of the first bar 105, and suitable for the first bar 105 to move therein in the first direction X. The fifth transmission part 118 comprises a first end connected to the first driving assembly 106 and a second end connected to the fourth driving assembly 107. The middle of the fifth transmission part 118 is connected to the first bar 105. The first bar 105 is configured to be driven by the fifth transmission part 118 in the first direction X according to the movement of the first driving assembly 106 or the movement of the fourth driving assembly 107.

In other embodiments, the first locking assembly 104 can comprise other elements. The scope of the present disclosure is not intended to be limited in this respect.

In the embodiment as shown in FIG. 3, the first elastic part 117 is a spring. In other embodiments, the first elastic part 117 can comprise other elements. The scope of the present disclosure is not intended to be limited in this respect.

In the embodiment as shown in FIG. 3, the fifth transmission part 118 is a straight transmission part comprises a first end and a second end. The first end of the straight transmission part comprises a groove used to accommodate the cylinder on the second end of the second transmission part 111. The second end of the straight transmission part is connected to the fourth transmission part 114. In other embodiments, the fifth transmission part 118 can comprise other elements. The scope of the present disclosure is not intended to be limited in this respect.

FIG. 10 is a schematic view illustrating a first bar and a second bar in accordance with an embodiment of the present disclosure. As shown in FIG. 10, the first bar 105 comprises a first portion 146 having a first groove 147, a second portion 148 having a second groove 149, and a second elastic part 145. The second elastic part 145 is disposed between the first groove 147 and the second groove 149.

When the first bar is driven to the first locking position, if the protrusion 136 of blocker 135 is directly under the first bar, the second elastic part 145 will be compressed. With this structure, the rigidity damage of the first bar can be avoided.

In other embodiments, the first bar 105 can comprise other elements. The scope of the present disclosure is not intended to be limited in this respect.

As shown in FIG. 3, the second interlock mechanism 103 comprises a second locking assembly 119, a second driving assembly 121, and a third driving assembly 122. The second locking assembly 119 comprises a second bar 120 which is movable in the first direction X. The second driving assembly 121 is connected to the second locking assembly 119 and is used to drive the second bar 120 to different positions in the first direction X according to different switch states of the second switch S2. The third driving assembly 122 is connected to the second locking assembly 119 and is used to drive the second bar 120 to different positions in the first direction X according to different switch states of the third switch S3.

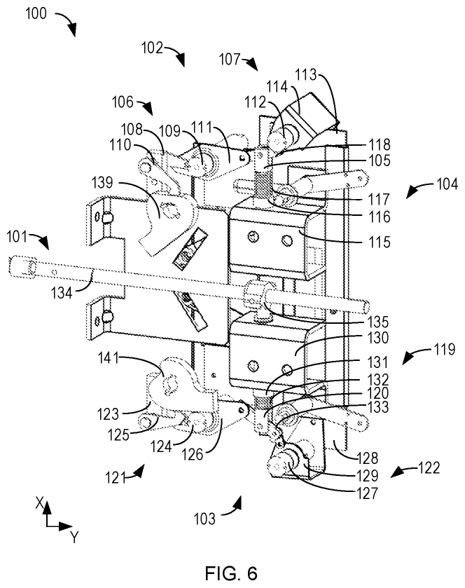

When the second switch S2 and the third switch S3 are both switched on, the second bar 120 is driven to a second locking position as shown in FIG. 6, so as to prevent the RIRO mechanism 101 from driving the ATSE from the non-operating position to the operating position. When either of the second switch S2 and the third switch S3 is not switched on, the second bar 120 is driven to other positions as shown in FIGS. 3-5 and 7-8, so as to not prevent the RIRO mechanism 101 from driving the ATSE from the non-operating position to the operating position.

As shown in FIG. 3, the second driving assembly 121 comprises a fifth support 123, a sixth support 124, a sixth transmission part 125, and a seventh transmission part 126. The sixth transmission part 125 is mounted on the fifth support 123 and is coupled to the second switch S2 through the second cam 141. The sixth transmission part 125 is configured to rotate relative to the fifth support 123 when the second switch S2 is switched between an ON state and an OFF state. The seventh transmission part 126 is mounted on the sixth support 124 and is connected to the sixth transmission part 125. The seventh transmission part 126 is configured to be driven by the sixth transmission part 125 to rotate relative to the sixth support 124 in a direction opposite to the rotate direction of the sixth transmission part 125.

In other embodiments, the second driving assembly 121 can comprise other elements. The scope of the present disclosure is not intended to be limited in this respect.

In the embodiment as shown in FIG. 3, the sixth transmission part 125 comprises a shaft mounted in a hole in the fifth support 123 and a first portion and a second portion mounted on the sides of the shaft. The first portion and the second portion of the sixth transmission part 125 are offset by a certain angle on the circumferential direction of the shaft. The second portion of the sixth transmission part 125 comprises a cylinder. In other embodiments, the sixth transmission part 125 can comprise other elements. The scope of the present disclosure is not intended to be limited in this respect.

In the embodiment as shown in FIG. 3, the seventh transmission part 126 comprises a first end and a second end. The first end of the seventh transmission part 126 comprises a groove to accommodate the cylinder on the second portion of the sixth transmission part 125. The second end of the seventh transmission part 126 comprises a cylinder. In other embodiments, the seventh transmission part 126 can comprise other elements. The scope of the present disclosure is not intended to be limited in this respect.

As shown in FIG. 3, the third driving assembly 122 comprises a seventh support 127, an eighth transmission part 128, and a ninth transmission part 129. The eighth transmission part 128 is connected to the third switch S3 through the first link 142. The eighth transmission part 128 is configured to move in the second direction Y when the third switch S3 is switched between an ON state and an OFF state. The ninth transmission part 129 is mounted on the seventh support 127 and is connected to the eighth transmission 128. The ninth transmission part 129 is configured to rotate relative to the seventh support 127 when the eighth transmission part 128 is moving in the second direction Y.

In other embodiments, the third driving assembly 122 can comprise other elements. The scope of the present disclosure is not intended to be limited in this respect.

In the embodiment as shown in FIG. 2, the ninth transmission part 129 is a U type transmission part comprising a cylinder on one side of the U type transmission part. In other embodiments, the ninth transmission part 129 can comprise other elements. The scope of the present disclosure is not intended to be limited in this respect.

In the embodiment as shown in FIG. 2, the eighth transmission 128 is a sheet comprising a groove that used to accommodate the cylinder on the U type transmission part. In other embodiments, the eighth transmission 128 can comprise other elements. The scope of the present disclosure is not intended to be limited in this respect.

As shown in FIG. 3, the second locking assembly 119 further comprises an eighth support 130, a second sleeve 131, a third elastic part 132, and a tenth transmission part 133. The eighth support 130 comprising a second hole. The second sleeve 131 is mounted in the second hole and suitable for the second bar 120 to move therein in the first direction X. The third elastic part 132 is coupled between the second sleeve 131 and a step of the second bar 120 and suitable for the second bar 120 to move therein in the first direction X. The tenth transmission part 133 comprises a first end connected to the second driving assembly 121 and a second end connected to the third driving assembly 122. The middle of tenth transmission part 133 is connected to the second bar 120. The second bar 120 is configured to be driven by the tenth transmission part 133 in the first direction X according to the movement of the second driving assembly 121 or the movement of the third driving assembly 122.

In other embodiments, the second locking assembly 119 can comprise other elements. The scope of the present disclosure is not intended to be limited in this respect.

In the embodiment as shown in FIG. 3, the third elastic part 132 is a spring. In other embodiments, the third elastic part 132 can comprise other elements. The scope of the present disclosure is not intended to be limited in this respect.

In the embodiment as shown in FIG. 3, the tenth transmission part 133 is a straight transmission part comprises a first end and a second end. The first end of the straight transmission part comprises a groove used to accommodate the cylinder on the second end of the seventh transmission part 126. The second end of the straight transmission part is connected to the ninth transmission part 129. In other embodiments, the tenth transmission part 133 can comprise other elements. The scope of the present disclosure is not intended to be limited in this respect.

As shown in FIG. 10, the second bar 120 comprises a third portion 153 having a third groove 154, a fourth portion 151 having a fourth groove 152, and a fourth elastic part 150. The fourth elastic part 150 is disposed between the third groove 154 and the fourth groove 152. In other embodiments, the second bar 120 can comprise other elements. The scope of the present disclosure is not intended to be limited in this respect.

FIGS. 3-8 illustrate first-sixth states of the interlock device 100 in accordance with an embodiment of the present disclosure.

As shown in FIG. 3, the first switch S1 and the fourth switch S4 are switched on, and the second switch S2 and the third switch S3 are switched off. In this situation, if the ATSE is racked in, the load will be connected to the utility through the first switch S1 and connected to the generator set through the fourth switch S4, and a short-circuit between the utility and the generator set will occur.

In this case, for the first interlock mechanism 102, as the first switch S1 and the fourth switch S4 are both switched on, when the ATSE is being racked in, the first cam 139 will drive the first transmission part 110 to rotate anti-clockwise, thereby driving the second transmission part 111 rotate clockwise, which in turn will drive the fifth transmission part 118 anti-clockwise, thereby driving the first bar 105 from a first position to the first locking position, i.e., its lowest position.

At the same time, for the second interlock mechanism 103, as the second switch S2 and the third switch S3 are both switched off, when the ATSE is being racked in, the second cam 141 will not drive the sixth transmission part 125 to rotate or to drive the sixth transmission part 125 to rotate much less as compared with the situation when the second switch S2 is switched on, and the second bar 120 will stay at a second position, i.e., its lowest position, or raise a little from the second position.

As a result, the first bar 105 will stop the blocker 135 to rotate, and prevent the RIRO mechanism from driving the ATSE from the non-operating position to the operating position. Therefore, a short-circuit between the utility and the generator set is prevented.

Referring to FIG. 4, FIG. 4 is a schematic view illustrating a second state of the interlock device in accordance with an embodiment of the present disclosure. As shown in FIG. 4, the first switch S1 is switched on, and the second switch S2, the third switch S3 and the fourth switch S4 are switched off. In this situation, if the ATSE is racked in, the load will be only connected to the utility through the first switch S1, and a short-circuit between the utility and the generator set will not occur.

In this case, for the first interlock mechanism 102, as the fourth switch S4 is switched off, the third transmission part 113 is driven to move in the second direction Y, thereby driving the fourth transmission part 114 to rotate clockwise, which will drive the fifth transmission part 118 to rotate anti-clockwise, thereby driving the first bar 105 to a third positon higher than the first positon. As the first switch S1 is switched on, when the ATSE is being racked in, the first cam 139 will drive the first transmission part 110 to rotate anti-clockwise, which in turn will drive the second transmission part 111 rotate clockwise, thereby driving the fifth transmission part 118 anti-clockwise, which in turn will drive the first bar 105 from the third position to a fourth position higher than the first locking position but lower than the third position.

At the same time, for the second interlock mechanism 103, as the second switch S2 and the third switch S3 are both switched off, when the ATSE is being racked in, the second bar 120 will stay at a second position or raise a little from the second position, as described regarding the FIG. 3.

As a result, the first bar 105 and the second bar 120 will not stop the blocker 135 to rotate, and will not prevent the RIRO mechanism from driving the ATSE from the non-operating position to the operating position. Therefore, the ATSE can be racked in in this case.

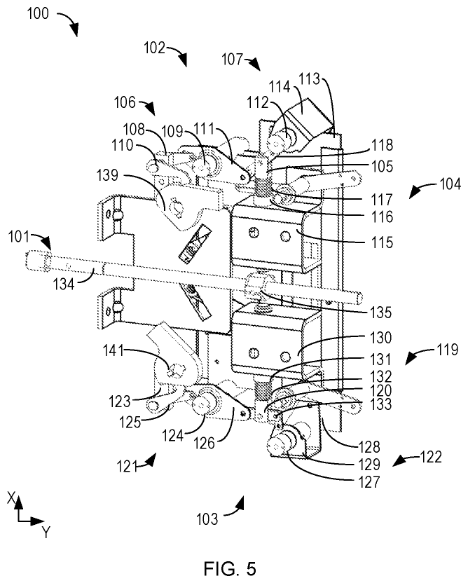

Referring to FIG. 5, FIG. 5 is a schematic view illustrating a third state of the interlock device in accordance with an embodiment of the present disclosure. As shown in FIG. 5, the first switch S1 and the third switch S3 are switched on, and the second switch S2 and the fourth switch S4 are switched off. In this situation, if the ATSE is racked in, the load will be connected to the utility through the first switch S1 and through the third switch S3, and a short-circuit between the utility and the generator set will not occur.

In this case, for the first interlock mechanism 102, as the first switch S1 is switched on and the fourth switch S4 is switched off, when the ATSE is being racked in, the first bar 105 will be driven from the third position to the fourth position, as described regarding the FIG. 4.

At the same time, for the second interlock mechanism 103, as the third switch S3 is switched on, the eighth transmission 128 is driven to move in the second direction Y, thereby driving the ninth transmission part 129 to rotate clockwise, which will drive the tenth transmission part 133 to rotate anti-clockwise, thereby driving the second bar 120 to a fifth positon higher than the second positon. The fifth position will not stop the blocker 135 to rotate. As the second switch S2 is switched off, when the ATSE is being racked in, the second cam 141 will not drive the sixth transmission part 125 to rotate or to drive the sixth transmission part 125 to rotate much less as compared with the situation when the second switch S2 is switched on, and the second bar 120 will stay at the fifth position, or raise a little from the fifth position.

As a result, the first bar 105 and the second bar 120 will not stop the blocker 135 to rotate, and will not prevent the RIRO mechanism from driving the ATSE from the non-operating position to the operating position. Therefore, the ATSE can be racked in in this case.

Referring to FIG. 6, FIG. 6 is a schematic view illustrating a fourth state of the interlock device in accordance with an embodiment of the present disclosure. As shown in FIG. 6, the second switch S2 and the third switch S3 are switched on, and the first switch S1 and the fourth switch S4 are switched off. In this situation, if the ATSE is racked in, the load will be connected to the utility through the third switch S3, and connected to the generator set through the second switch S2, and a short-circuit between the utility and the generator set will occur.

In this case, for the first interlock mechanism 102, as the first switch S1 and the fourth switch S4 are both switched off, when the ATSE is being racked in, the first cam 139 will not drive the first transmission part 110 to rotate or to drive the first transmission part 110 to rotate much less as compared with the situation when the first switch S1 is switched on, and the first bar 105 will stay at the third position or descend a little from the third position.

At the same time, for the second interlock mechanism 103, as the second switch S2 and the third switch S3 are both switched on, when the ATSE is being racked in, the second cam 141 will drive the sixth transmission part 125 to rotate clockwise, thereby driving the seventh transmission part 126 rotate anti-clockwise, which in turn will drive the tenth transmission part 133 clockwise, thereby driving the second bar 120 from the fifth position to the second locking position.

As a result, the second bar 120 will stop the blocker 135 to rotate, and prevent the RIRO mechanism from driving the ATSE from the non-operating position to the operating position. Therefore, a short-circuit between the utility and the generator set is prevented.

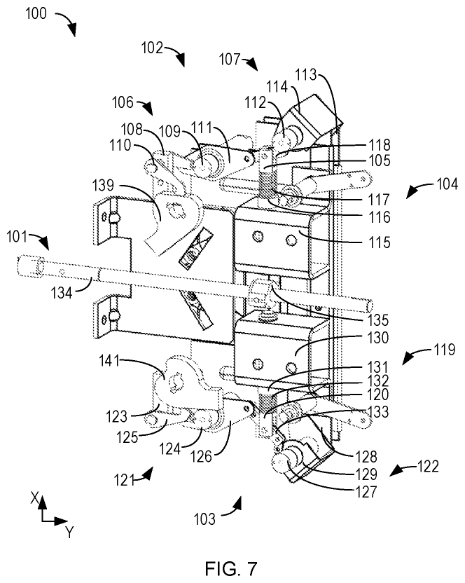

Referring to FIG. 7, FIG. 7 is a schematic view illustrating a fifth state of the interlock device in accordance with an embodiment of the present disclosure. As shown in FIG. 7, the second switch S2 is switched on, and the first switch S1, the third switch S3 and the fourth switch S4 are switched off. In this situation, if the ATSE is racked in, the load will be only connected to the generator set through the second switch S2, and a short-circuit between the utility and the generator set will not occur.

In this case, for the first interlock mechanism 102, as the first switch S1 and the fourth switch S4 are both switched off, when the ATSE is being racked in, the first bar 105 will stay at the third position or descend a little from the third position, as described regarding the FIG. 6.

At the same time, for the second interlock mechanism 103, as the second switch S2 is switched on and the third switch S3 is switched off, when the ATSE is being racked in, the second cam 141 will drive the sixth transmission part 125 to rotate clockwise, thereby driving the seventh transmission part 126 rotate anti-clockwise, which in turn will drive the tenth transmission part 133 clockwise, thereby driving the second bar 120 from the second position to a sixth position lower than the second locking position but higher than the second position.

As a result, the first bar 105 and the second bar 120 will not stop the blocker 135 to rotate, and will not prevent the RIRO mechanism from driving the ATSE from the non-operating position to the operating position. Therefore, the ATSE can be racked in in this case.

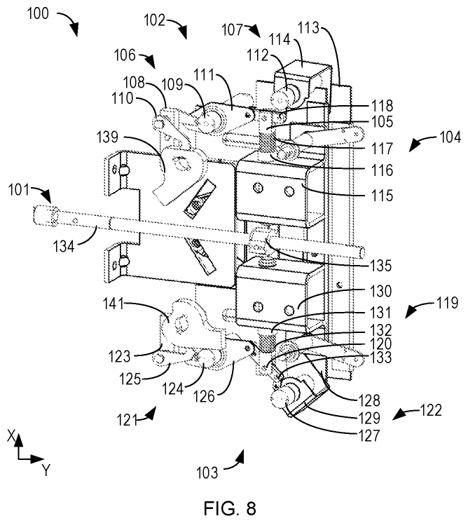

Referring to FIG. 8, FIG. 8 is a schematic view illustrating a sixth state of the interlock device in accordance with an embodiment of the present disclosure. As shown in FIG. 8, the first switch S1 and the third switch S3 are switched off, and the second switch S2 and the fourth switch S4 are switched on. In this situation, if the ATSE is racked in, the load will be connected to the generator set through the second switch S2 and through the fourth switch S4, and a short-circuit between the utility and the generator set will not occur.

In this case, for the first interlock mechanism 102, as the first switch S1 is switched off and the fourth switch S4 is switched on, when the ATSE is being racked in, the first cam 139 will not drive the first transmission part 110 to rotate or to drive the first transmission part 110 to rotate much less as compared with the situation when the first switch S1 is switched on, and the first bar 105 will stay at the first position or descend a little from the first position.

At the same time, for the second interlock mechanism 103, as the second switch S2 is switched on and the third switch S3 is switched off, when the ATSE is being racked in, the second bar 120 is driven from the second position to a sixth position, as described regarding the FIG. 7.

As a result, the first bar 105 and the second bar 120 will not stop the blocker 135 to rotate, and will not prevent the RIRO mechanism from driving the ATSE from the non-operating position to the operating position. Therefore, the ATSE can be racked in in this case.

The control logic of the switches S1-S4 is represented in Table 1 as below.

TABLE 1

| | | | | | First | Second |
|---|---|---|---|---|---|---|
| | | | | | interlock | interlock |
| State No. | S1 | S2 | S3 | S4 | mechanism | mechanism |
| 1 | Closed | Open | Open | Closed | Locked | Unlocked |
| 2 | Closed | Open | Open | Open | Unlocked | Unlocked |
| 3 | Closed | Open | Closed | Open | Unlocked | Unlocked |
| 4 | Open | Closed | Closed | Open | Unlocked | Locked |
| 5 | Open | Closed | Open | Open | Unlocked | Unlocked |
| 6 | Open | Closed | Open | Closed | Unlocked | Unlocked |

Through the above interlock device 100, when the ATSE is racked in, the states of the switches S1-S4 are determined by the interlock device 100 automatically without requiring sensors, and the interlock device 100 will automatically prevent the occurrence of the short circuit between the first and the second power supplies.

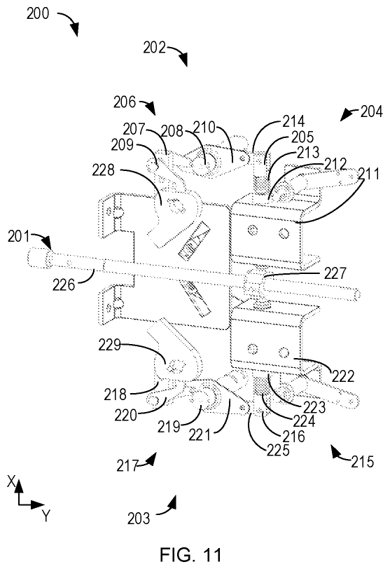

Hereinafter, the structure of an interlock device 200 in accordance with another embodiment of the present disclosure will be described in detail with reference to FIGS. 11-13. The interlock device 200 relates to a bypass device comprising a three-position ATSE and a three-position MTSE. FIG. 11 is a schematic view illustrating a first state of the interlock device in accordance with another embodiment of the present disclosure.

As shown in FIG. 11, the interlock mechanism 200 comprises a RIRO mechanism 201, a first interlock mechanism 202, and a second interlock mechanism 203. The RIRO mechanism 201 is used to drive the ATSE from a non-operating position to an operating position and drive the ATSE from the operating position to the non-operating position. The first interlock mechanism 202 is configured to allow the RIRO mechanism 201 from driving the ATSE from the non-operating position to the operating position when the first switch S1 is switched off. The second interlock mechanism 203 is configured to allow the RIRO mechanism 201 from driving the ATSE from the non-operating position to the operating position when the second switch S2 is switched off.

As shown in FIG. 11, the first interlock mechanism 202 comprises a first locking assembly 204 and a first driving assembly 206. The first locking assembly 204 comprises a first bar 205 which is movable in a first direction X. The first driving assembly 206 is connected to the first locking assembly 204 and configured to drive the first bar 205 to different positions in the first direction X according to different switch states of the first switch S1.

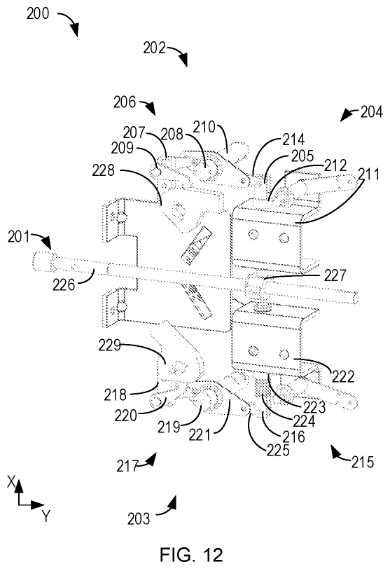

When the first switch S1 is switched on, as shown in FIG. 12, the first bar 205 is driven to a first locking position that will prevent the RIRO mechanism 201 from driving the ATSE from the non-operating position to the operating position. When the first switch S1 is switched off, the first bar 205 is driven to another position that will not prevent the RIRO mechanism 201 from driving the ATSE from the non-operating position to the operating position.

As shown in FIG. 11, the first driving assembly 206 comprises a first support 207, a second support 208, a first transmission part 209, and a second transmission part 210. The first transmission part 209 is mounted on the first support 207 and coupled to the first switch S1 through the first cam 228. The first transmission part 209 is configured to rotate relative to the first support 207 when the first switch S1 is switched between an ON state and an OFF state. The second transmission part 210 is mounted on the second support 208 and is connected to the first transmission part 209 and the first locking assembly 204. The second transmission part 210 is configured to be driven by the first transmission part 209 to rotate relative to the second support 208 in a direction opposite to the rotate direction of the first transmission part 209.

In other embodiments, the first driving assembly 206 can comprise other elements. The scope of the present disclosure is not intended to be limited in this respect.

The detailed structures of the first transmission part 209 and the second transmission part 210 are similar with the first transmission part 110 and the second transmission part 111 respectively, as described regarding the FIG. 3.

As shown in FIG. 11, the first locking assembly 204 further comprises a third support 211, a first sleeve 212, a first elastic part 213, and a third transmission part 214. The third support 211 comprising a first hole. The first sleeve 212 is mounted in the first hole and suitable for the first bar 205 to move therein in the first direction X. The first elastic part 213 is coupled between the first sleeve 212 and a step of the first bar 205 and suitable for the first bar 205 to move therein in the first direction X. The third transmission part 214 is fixedly connected to the first bar 205 and is connected to the first driving assembly 206. The first bar 205 is driven by the third transmission part 214 in the first direction X according to the movement of the first driving assembly 206.

In other embodiments, the first locking assembly 204 can comprise other elements. The scope of the present disclosure is not intended to be limited in this respect.

In the embodiment as shown in FIG. 11, the third transmission part 214 is a straight transmission part comprises a first end and a second end. The first end of the straight transmission part comprises a groove used to accommodate the cylinder on the second end of the second transmission part 210. The second end of the straight transmission part is fixedly connected to the first bar 205. In other embodiments, the third transmission part 214 can comprise other elements. The scope of the present disclosure is not intended to be limited in this respect.

As shown in FIG. 11, the second interlock mechanism 203 comprises a second locking assembly 215 and a second driving assembly 217. The second locking assembly 215 comprises a second bar 216 which is movable in a first direction X. The second driving assembly 217 is connected to the second locking assembly 215 and configured to drive the second bar 216 to different positions in the first direction X according to different switch states of the second switch S2.

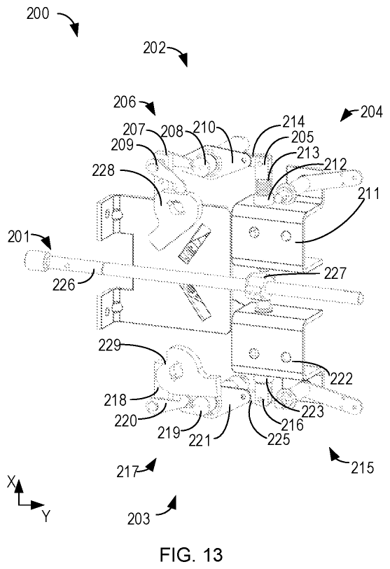

When the second switch S2 is switched on, as shown in FIG. 13, the second bar 216 is driven to a second locking position that will prevent the RIRO mechanism 201 from driving the ATSE from the non-operating position to the operating position. When the second switch S2 is switched off, the second bar 216 is driven to another position that will not prevent the RIRO mechanism 201 from driving the ATSE from the non-operating position to the operating position.

As shown in FIG. 11, the second driving assembly 217 comprises a fourth support 218, a fifth support 219, a fourth transmission part 220, and a fifth transmission part 221. The fourth transmission part 220 is mounted on the fourth support 218 and coupled to the second switch S2 through the second cam 229. The fourth transmission part 220 is configured to rotate relative to the fourth support 218 when the second switch S2 is switched between an ON state and an OFF state. The fifth transmission part 221 is mounted on the fifth support 219 and is connected to the fourth transmission part 220 and the second locking assembly 215. The fifth transmission part 221 is configured to be driven by the fourth transmission part 220 to rotate relative to the fifth support 219 in a direction opposite to the rotate direction of the fourth transmission part 220.

In other embodiments, the second driving assembly 217 can comprise other elements. The scope of the present disclosure is not intended to be limited in this respect.

The detailed structures of the fourth transmission part 220 and the fifth transmission part 221 are similar with the sixth transmission part 125 and the seventh transmission part 126 respectively, as described regarding the FIG. 3.

As shown in FIG. 11, the second locking assembly 215 further comprises a sixth support 222, a second sleeve 223, a third elastic part 224, and a sixth transmission part 225. The sixth support 222 comprises a second hole. The second sleeve 223 is mounted in the second hole and suitable for the second bar 216 to move therein in the first direction X. The third elastic part 224 is coupled between the second sleeve 223 and a step of the second bar 216 and suitable for the second bar 216 to move therein in the first direction X. The sixth transmission part 225 is fixedly connected to the second bar 216 and is connected to the second driving assembly 217. The second bar 216 is driven by the sixth transmission part 225 in the first direction X according to the movement of the second driving mechanism.

In other embodiments, the second locking assembly 215 can comprise other elements. The scope of the present disclosure is not intended to be limited in this respect.

In the embodiment as shown in FIG. 11, the sixth transmission part 225 is a straight transmission part comprises a first end and a second end. The first end of the straight transmission part comprises a groove used to accommodate the cylinder on the second end of the fifth transmission part 221. The second end of the straight transmission part is fixedly connected to the second bar 216. In other embodiments, the sixth transmission part 225 can comprise other elements. The scope of the present disclosure is not intended to be limited in this respect.

The detailed structures of the RIRO mechanism 201, the first elastic part 213, the third elastic part 224, the first bar 205 and the second bar 216 are similar with the RIRO mechanism 101, the first elastic part 117, the third elastic part 132, the first bar 105 and the second bar 120 respectively, as described regarding the FIGS. 3 and 10.

FIGS. 11-13 illustrate first-third states of the interlock device 200 in accordance with another embodiment of the present disclosure.

As shown in FIG. 11, the first switch S1 and the second switch S2 are both switched off. In this situation, the load will not be connected to the utility or the generator set, and it is impossible that a short-circuit between the utility and the generator set occurs.

In this case, for the first interlock mechanism 202, as the first switch S1 is switched off, when the ATSE is being racked in, the first cam 228 will not drive the first transmission part 209 to rotate or to drive the first transmission part 209 to rotate much less as compared with the situation when the first switch S1 is switched on. The first bar 205 will stay at a first position or descend a little from the first position.

At the same time, for the second interlock mechanism 203, as the second switch S2 is switched off, when the ATSE is being racked in, the second cam 229 will not drive the fourth transmission part 220 to rotate or to drive the fourth transmission part 220 to rotate much less as compared with the situation when the second switch S2 is switched on. The second bar 216 will stay at a second position or descend a little from the second position.

As a result, the first bar 205 and the second bar 216 will not stop the blocker 227 to rotate, and will not prevent the RIRO mechanism from driving the ATSE from the non-operating position to the operating position. Therefore, the ATSE can be racked in in this case.

Referring to FIG. 12, FIG. 12 is a schematic view illustrating a second state of the interlock device in accordance with another embodiment of the present disclosure. As shown in FIG. 12, the first switch S1 is switched on and the second switch S2 is switched off. In this situation, if the ATSE is racked in, the load will be connected to the utility through the first switch S1. If the load is connected to the utility through the third switch S3 at the same time, a short-circuit between the utility and the generator set occurs.

In this case, for the first interlock mechanism 202, as the first switch S1 is switched on, when the ATSE is being racked in, the first cam 228 will drive the first transmission part 209 to rotate anti-clockwise, which in turn will drive the second transmission part 210 rotate clockwise, thereby driving the first bar 205 from the first position to the first locking position.

At the same time, for the second interlock mechanism 203, as the second switch S2 is switched off, when the ATSE is being racked in, the second bar 216 will stay at the second position or descend a little from the second position, as described regarding the FIG. 11.

As a result, the first bar 205 will stop the blocker 227 to rotate, and prevent the RIRO mechanism from driving the ATSE from the non-operating position to the operating position. Therefore, a potential short-circuit between the utility and the generator set is prevented.

Referring to FIG. 13, FIG. 13 is a schematic view illustrating a third state of the interlock device in accordance with another embodiment of the present disclosure. As shown in FIG. 13, the first switch S1 is switched off and the second switch S2 is switched on. In this situation, if the ATSE is racked in, the load will be connected to the generator set through the second switch S2. If the load is connected to the generator set through the fourth switch S4 at the same time, a short-circuit between the utility and the generator set occurs.

In this case, for the first interlock mechanism 202, as the first switch S1 is switched off, when the ATSE is being racked in, the first bar 205 will stay at the first position or descend a little from the first position, as described regarding the FIG. 11.

At the same time, for the second interlock mechanism 203, as the second switch S2 is switched on, when the ATSE is being racked in, the second cam 229 will drive the fourth transmission part 220 to rotate clockwise, which in turn will drive the fifth transmission part 221 rotate anti-clockwise, thereby driving the second bar 216 from the second position to the second locking position.

As a result, the second bar 216 will stop the blocker 227 to rotate, and prevent the RIRO mechanism from driving the ATSE from the non-operating position to the operating position. Therefore, a potential short-circuit between the utility and the generator set is prevented.

The control logic of the switches S1-S2 is represented in Table 2 as below.

TABLE 2

| | | | First interlock | Second interlock |
|---|---|---|---|---|
| State No. | S1 | S2 | mechanism | mechanism |
| 1 | Open | Open | Unlocked | Unlocked |
| 2 | Closed | Open | Locked | Unlocked |
| 3 | Open | Closed | Unlocked | Locked |

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An interlock device for a bypass device, the bypass device being configured to switch a load between a first power supply and a second power supply and comprising a two-position Automatic Transfer Switching Equipment (ATSE) having a first switch and a second switch and a three-position Manual Transfer Switching Equipment (MTSE) having a third switch and a fourth switch, each of the first switch and the third switch being configured to connect the load to the first power supply or disconnect the load from the first power supply, and each of the second switch and the fourth switch being configured to connect the load to the second power supply or disconnect the load from the second power supply, the interlock mechanism comprising:
a Rack In Rack Out (RIRO) mechanism, configured to drive the ATSE from a non-operating position to an operating position and drive the ATSE from the operating position to the non-operating position;
a first interlock mechanism, configured to prevent the RIRO mechanism from driving the ATSE from the non-operating position to the operating position when the first switch and the fourth switch are both switched on; and
a second interlock mechanism, configured to prevent the RIRO mechanism from driving the ATSE from the non-operating position to the operating position when the second switch and the third switch are both switched on.

2. The interlock device according to claim 1, wherein the first interlock mechanism comprises:
a first locking assembly, comprising a first bar which is movable in a first direction;
a first driving assembly, connected to the first locking assembly and configured to drive the first bar to different positions in the first direction according to different switch states of the first switch;
a fourth driving assembly, connected to the first locking assembly and configured to drive the first bar to different positions in the first direction according to different switch states of the fourth switch,
wherein when the first switch and the fourth switch are both switched on, the first bar is driven to a first locking position so as to prevent the RIRO mechanism from driving the ATSE from the non-operating position to the operating position; and
when either of the first switch and the fourth switch is not switched on, the first bar is driven to other positions so as to not prevent the RIRO mechanism from driving the ATSE from the non-operating position to the operating position.

3. The interlock device according to claim 2, wherein the first driving assembly comprises:
a first support;
a second support;
a first transmission part mounted on the first support and coupled to the first switch, wherein the first transmission part is configured to rotate relative to the first support when the first switch is switched between an ON state and an OFF state; and
a second transmission part mounted on the second support and connected to the first transmission part, wherein the second transmission part is configured to be driven by the first transmission part to rotate relative to the second support in a direction opposite to the rotate direction of the first transmission part.

4. The interlock device according to claim 2, wherein the fourth driving assembly comprises:
a third support;
a third transmission part connected to the fourth switch, wherein the third transmission part is configured to move in a second direction when the fourth switch is switched between an ON state and an OFF state; and
a fourth transmission part mounted on the third support and connected to the third transmission, wherein the fourth transmission part is configured to rotate relative to the third support when the third transmission part is moving in the second direction.

5. The interlock device according to claim 2, wherein the first locking assembly further comprises:
a fourth support comprising a first hole;
a first sleeve mounted in the first hole and suitable for the first bar to move therein in the first direction;
a first elastic part coupled between the first sleeve and a step of the first bar and suitable for the first bar to move therein in the first direction; and
a fifth transmission part comprising a first end connected to the first driving assembly and a second end connected to the fourth driving assembly,
wherein the fifth transmission part is connected to the first bar,
wherein the first bar is configured to be driven by the fifth transmission part in the first direction according to the movement of the first driving assembly or the movement of the fourth driving assembly.

6. The interlock device according to claim 2, wherein the first bar comprises a first portion having a first groove, a second portion having a second groove, and a second elastic part, wherein the second elastic part is disposed between the first groove and the second groove.

7. The interlock device according to claim 1, wherein the second interlock mechanism comprises:
a second locking assembly, comprising a second bar which is movable in the first direction;
a second driving assembly, connected to the second locking assembly and configured to drive the second bar to different positions in the first direction according to different switch states of the second switch;
a third driving assembly, connected to the second locking assembly and configured to drive the second bar to different positions in the first direction according to different switch states of the third switch,
wherein when the second switch and the third switch are both switched on, the second bar is driven to a second locking position so as to prevent the RIRO mechanism from driving the ATSE from the non-operating position to the operating position;
and when either of the second switch and the third switch is not switched on, the second bar is driven to other positions so as to not prevent the RIRO mechanism from driving the ATSE from the non-operating position to the operating position.

8. The interlock device according to claim 7, wherein the second driving assembly comprises:
a fifth support;
a sixth support;
a sixth transmission part mounted on the fifth support and coupled to the second switch, wherein the sixth transmission part is configured to rotate relative to the fifth support when the second switch is switched between an ON state and an OFF state; and
a seventh transmission part mounted on the sixth support and connected to the sixth transmission part, wherein the seventh transmission part is configured to be driven by the sixth transmission part to rotate relative to the sixth support in a direction opposite to the rotate direction of the sixth transmission part.

9. The interlock device according to claim 7, wherein the third driving assembly comprises:
a seventh support;
an eighth transmission part connected to the third switch, wherein the eighth transmission part is configured to move in the second direction when the third switch is switched between an ON state and an OFF state; and
a ninth transmission part mounted on the seventh support and connected to the eighth transmission, wherein the ninth transmission part is configured to rotate relative to the seventh support when the eighth transmission part is moving in the second direction.

10. The interlock device according to claim 7, wherein the second locking assembly further comprises:
an eighth support comprising a second hole;
a second sleeve mounted in the second hole and suitable for the second bar to move therein in the first direction;
a third elastic part coupled between the second sleeve and a step of the second bar and suitable for the second bar to move therein in the first direction; and
a tenth transmission part comprising a first end connected to the second driving assembly and a second end connected to the third driving assembly,
wherein the tenth transmission part is connected to the second bar,
wherein the second bar is configured to be driven by the tenth transmission part in the first direction according to the movement of the second driving assembly or the movement of the third driving assembly.

11. The interlock device according to claim 7, wherein the second bar comprises a third portion having a third groove, a fourth portion having a fourth groove, and a fourth elastic part, wherein the fourth elastic part is disposed between the third groove and the fourth groove.

12. The interlock device according to claim 1, wherein the RIRO mechanism comprises a rocking bar and a blocker fixed on the rocking bar, the blocker comprises a protrusion on its periphery, wherein a distance from one side of the protrusion to a center of the blocker is shorter than a distance from the other side of the protrusion to the center of the blocker.

13. An interlock device for a bypass device, the bypass device being configured to switch a load between a first power supply and a second power supply and comprising a three-position Automatic Transfer Switching Equipment (ATSE) having a first switch and a second switch and a three-position Manual Transfer Switching Equipment (MTSE) having a third switch and a fourth switch, each of the first switch and the third switch being configured to connect the load to the first power supply or disconnect the load from the first power supply, and each of the second switch and the fourth switch being configured to connect the load to the second power supply or disconnect the load from the second power supply, the interlock mechanism comprising:
a Rack In Rack Out (RIRO) mechanism, configured to drive the ATSE from a non-operating position to an operating position and drive the ATSE from the operating position to the non-operating position;
a first interlock mechanism, configured to allow the RIRO mechanism from driving the ATSE from the non-operating position to the operating position when the first switch is switched off; and
a second interlock mechanism, configured to allow the RIRO mechanism from driving the ATSE from the non-operating position to the operating position when the second switch is switched off.

14. The interlock device according to claim 13, wherein the first interlock mechanism comprises:
a first locking assembly, comprising a first bar which is movable in a first direction;
a first driving assembly, connected to the first locking assembly and configured to drive the first bar to different positions in the first direction according to different switch states of the first switch,
wherein when the first switch is switched on, the first bar is driven to a first locking position that will prevent the RIRO mechanism from driving the ATSE from the non-operating position to the operating position; when the first switch is switched off, the first bar is driven to another position that will not prevent the RIRO mechanism from driving the ATSE from the non-operating position to the operating position.

15. The interlock device according to claim 14, wherein the first driving assembly comprises:
a first support;
a second support;
a first transmission part mounted on the first support and coupled to the first switch, wherein the first transmission part is configured to rotate relative to the first support when the first switch is switched between an ON state and an OFF state; and
a second transmission part mounted on the second support and connected to the first transmission part and the first locking assembly, wherein the second transmission part is configured to be driven by the first transmission part to rotate relative to the second support in a direction opposite to the rotate direction of the first transmission part.

16. The interlock device according to claim 14, wherein the first locking assembly further comprises:
a third support comprising a first hole;
a first sleeve mounted in the first hole and suitable for the first bar to move therein in the first direction;
a first elastic part coupled between the first sleeve and a step of the first bar and suitable for the first bar to move therein in the first direction; and
a third transmission part fixedly connected to the first bar and connected to the first driving assembly,
wherein the first bar is driven by the third transmission part in the first direction according to the movement of the first driving assembly.

17. The interlock device according to claim 14, wherein the first bar comprises a first portion having a first groove, a second portion having a second groove, and a second elastic part, wherein the second elastic part is disposed between the first groove and the second groove.

18. The interlock device according to claim 13, wherein the second interlock mechanism comprises:
a second locking assembly, comprising a second bar which is movable in a first direction;
a second driving assembly, connected to the second locking assembly and configured to drive the second bar to different positions in the first direction according to different switch states of the second switch;
wherein when the second switch is switched on, the second bar is driven to a second locking position that will prevent the RIRO mechanism from driving the ATSE from the non-operating position to the operating position; when the second switch is switched off, the second bar is driven to another position that will not prevent the RIRO mechanism from driving the ATSE from the non-operating position to the operating position.

19. The interlock device according to claim 18, wherein the second driving assembly comprises:
a fourth support;
a fifth support;
a fourth transmission part mounted on the fourth support and coupled to the second switch, wherein the fourth transmission part is configured to rotate relative to the fourth support when the second switch is switched between an ON state and an OFF state; and
a fifth transmission part mounted on the fifth support and connected to the fourth transmission part and the second locking assembly, wherein the fifth transmission part is configured to be driven by the fourth transmission part to rotate relative to the fifth support in a direction opposite to the rotate direction of the fourth transmission part.

20. The interlock device according to claim 18, wherein the second locking assembly further comprises:
a sixth support comprising a second hole;
a second sleeve mounted in the second hole and suitable for the second bar to move therein in the first direction;
a third elastic part coupled between the second sleeve and a step of the second bar and suitable for the second bar to move therein in the first direction; and
a sixth transmission part fixedly connected to the second bar and connected to the second driving assembly,
wherein the second bar is driven by the sixth transmission part in the first direction according to the movement of the second driving mechanism.

21. The interlock device according to claim 18, wherein the second bar comprises a third portion having a third groove, a fourth portion having a fourth groove, and a fourth elastic part, wherein the fourth elastic part is disposed between the third groove and the fourth groove.

22. The interlock device according to claim 13, wherein the RIRO mechanism comprises a rocking bar and a blocker fixed on the rocking bar, the blocker comprises a protrusion on its periphery, wherein a distance from one side of the protrusion to a center of the blocker is shorter than a distance from the other side of the protrusion to the center of the blocker.
